(19) United States
(12) Patent Application Publication
(10) Pub. No.: US 2019/0360393 A1
(43) Pub. Date: Nov. 28, 2019

(54) DIESEL ENGINE CLEANING SYSTEM AND METHOD OF USING THE SAME

(71) Applicant: Lyden Oil Company, Walbridge, OH (US)

(72) Inventor: Robert W. Brooks, Casnovia, MI (US)

(73) Assignee: Lyden Oil Company, Walbridge, OH (US)

(21) Appl. No.: 16/348,531

(22) PCT Filed: Nov. 14, 2017
(86) PCT No.: PCT/US17/61488

§ 371 Date: May 9, 2019

Related U.S. Application Data
(60) Provisional application No. 62/422,202, filed on Nov. 15, 2016.

(51) Int. Cl. F02B 77/04; B08B 3/00; B01F 3/04; B01F 5/02

(52) U.S. Cl. CPC F02B 77/04; B08B 3/003; B01F 2215/0077; B01F 5/0256; B01F 3/04446

(57) ABSTRACT

A diesel engine cleaning system is provided. The diesel engine cleaning system includes a reservoir configured to contain and pressurize cleaning liquid. A mixing assembly is configured to receive the pressurized cleaning liquid from the reservoir and also configured to form a compressed cleaning foam from a mixture of the pressurized cleaning liquid and compressed gas. One or more delivery lines is configured to deliver the compressed cleaning foam from the mixing assembly to select internal portions of the diesel engine. The compressed cleaning foam is configured to expand within the internal portions of the diesel engine and remove diesel particulate matter from surfaces of the internal portions of the diesel engine with the diesel engine running at low or idle speeds.

### RELATED APPLICATIONS

This application claims the benefit of U.S. Provisional Application No. 62/422,202, filed Nov. 15, 2016, the disclosure of which is incorporated herein by reference.

### BACKGROUND

Diesel engines (also known as compression-ignition or CI engines) are a type of internal combustion engine. A diesel engine operates through ignition of a fuel, which has been injected into a combustion chamber. The injected fuel is compressed within the combustion chamber and ignites as a result of a high temperature caused by the compression of air in the combustion chamber. Diesel engines work by compressing only the air, which increases the air temperature inside the combustion cylinder to such a high degree that it ignites atomized diesel fuel that is injected into the combustion chamber. The operation of diesel engines contrasts with spark-ignition engines, such as for example, a gasoline engine which use a spark plug to ignite an air-fuel mixture.

Diesel engines provide many benefits over gasoline engines. First, a diesel engine can burn less fuel than a gasoline engine performing the same work, due to the engine's higher temperature of combustion and greater expansion ratio. For example, in certain instances gasoline engines are typically 30% efficient while diesel engines can convert over 45% of the fuel energy into mechanical energy. Second, diesel engines operate without high voltage electrical ignition systems, which result in high reliability and easy adaptation to damp environments. Third, the absence of coils, spark plug wires, etc., also eliminates a source of radio frequency emissions which can interfere with navigation and communication equipment, which is especially important in marine and aircraft applications, and for preventing interference with radio telescopes. Fourth, the longevity of a diesel engine is generally about twice that of a gasoline engine due to the increased strength of the parts used and diesel fuel has better lubrication properties than gasoline as well.

The combustion process used in diesel engines are known to produce a diesel exhaust gas. The diesel exhaust gas can include fine particulate matter, such as the non-limiting example of soot. The fine particulate matter can accumulate in certain portions of the diesel engine, such as the non-limiting examples of the valves and the exhaust system. The composition of the fine particulate matter may vary with the fuel type or rate of consumption, or speed of engine operation (e.g., idling or at speed), and whether the engine is in an on-road vehicle, farm vehicle, locomotive, marine vessel, or stationary generator or other application

Diesel engines can include a diesel particulate filter (or DPF). A diesel particulate filter is a device positioned downstream from the diesel engine and designed to remove diesel particulate matter, such as soot, from the diesel exhaust gas.

Some diesel particulate filters are single-use applications. That is they are intended for disposal and replacement once the filter is full of accumulated diesel particulate matter. Other diesel particulate filters are designed to burn off the accumulated particulate matter either passively with a catalyst or by active means such as a fuel burner. A fuel burner is designed to heat the diesel particulate filter to combustion temperatures. This can be accomplished by programming the engine to run (when the diesel particulate filter is full of accumulated particulate matter) in a manner that elevates the exhaust temperature, in conjunction with an extra fuel injector in the exhaust stream that injects fuel to react with a catalyst element to burn off accumulated soot in the diesel particulate filter.

It would be advantageous if accumulated diesel particulate matter could be removed from diesel engines more easily.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the diesel engine cleaning system and method of use.

The above objects as well as other objects not specifically enumerated are achieved by a diesel engine cleaning system. The diesel engine cleaning system includes a reservoir configured to contain and pressurize cleaning liquid. A mixing assembly is configured to receive the pressurized cleaning liquid from the reservoir and also configured to form a compressed cleaning foam from a mixture of the pressurized cleaning liquid and compressed gas. One or more delivery lines is configured to deliver the compressed cleaning foam from the mixing assembly to select internal portions of the diesel engine. The compressed cleaning foam is configured to expand within the internal portions of the diesel engine and remove diesel particulate matter from surfaces of the internal portions of the diesel engine with the diesel engine running at low or idle speeds.

Other objects not specifically enumerated are achieved by a method of cleaning select internal portions of a diesel engine. The method comprises the steps of pressurizing a cleaning liquid, mixing the pressurized cleaning liquid with a compressed gas to form a compressed cleaning foam and conveying the compressed cleaning foam to select internal portions of the diesel engine and facilitating expansion of the compressed cleaning foam within the internal portions of the diesel engine such that the compressed cleaning form removes diesel particulate matter from surfaces of the internal portions of the diesel engine with the diesel engine running at low or idle speeds.

Other objects not specifically enumerated are achieved by a mixing assembly for use in a diesel engine cleaning system. The mixing assembly includes a body and one or more input ports connected to the body and configured to receive a pressurized cleaning liquid. One or more input ports is connected to the body and configured to receive pressurized gas. One or more mixing chambers is configured to receive the pressurized cleaning liquid and the pressurized gas. The one or more mixing chambers is further configured to form compressed cleaning foam from a mixture of the pressurized cleaning liquid and the pressurized gas. One or more delivery lines is in fluid communication with the one or more mixing chambers. The one or more delivery lines is configured to convey the compressed cleaning foam to select internal portions of the diesel engine.

Various aspects of the diesel engine cleaning system and method of use will become apparent to those skilled in the art from the following detailed description of the illustrated embodiments, when read in light of the accompanying drawings.

### BRIEF DESCRIPTION OF THE DRAWINGS

FIG. 1 is a perspective view of a diesel engine cleaning system.

FIG. 2 is a perspective view of the diesel engine cleaning system of FIG. 1 shown connected to a diesel engine.

FIG. 3 is a perspective view of the diesel engine cleaning system of FIG. 1, shown without an enclosure.

FIG. 4 is a perspective view of a compressed gas inlet assembly of the diesel engine cleaning system of FIG. 1.

FIG. 5 is a schematic illustration of the method of using the diesel engine cleaning system of FIG. 1.

FIG. 6 is a flow chart of the method of using the diesel engine cleaning system of FIG. 1.

FIG. 7 is a perspective view of a mixing assembly of the diesel engine cleaning system of FIG. 1.

FIG. 8 is a perspective view, partially in cross-section, of a mixing assembly of the diesel engine cleaning system of FIG. 1.

FIG. 9 is a side elevational view, partially in cross-section, of a mixing assembly of the diesel engine cleaning system of FIG. 1.

### DETAILED DESCRIPTION

The diesel engine cleaning system and method of use will now be described with occasional reference to the specific embodiments. The diesel engine cleaning system and method of use may, however, be embodied in different forms and should not be construed as limited to the embodiments set forth herein. Rather, these embodiments are provided so that this disclosure will be thorough and complete, and will fully convey the scope of the diesel engine cleaning system and method of use to those skilled in the art.

Unless otherwise defined, all technical and scientific terms used herein have the same meaning as commonly understood by one of ordinary skill in the art to which the diesel engine cleaning system and method of use belongs. The terminology used in the description of the diesel engine cleaning system and method of use herein is for describing particular embodiments only and is not intended to be limiting of the diesel engine cleaning system and method of use. As used in the description of the diesel engine cleaning system and method of use and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the diesel engine cleaning system and method of use. Notwithstanding that the numerical ranges and parameters setting forth the broad scope of the diesel engine cleaning system and method of use are approximations, the numerical values set forth in the specific examples are reported as precisely as possible. Any numerical values, however, inherently contain certain errors necessarily resulting from error found in their respective measurements.

The term “diesel engine”, as used herein, is defined to mean any apparatus using a compression ignition form of operation. The term “compression ignition”, as used herein, is defined to mean the injection of a fuel into a combustion chamber and the ignition of that fuel by the high temperature of an associated gas when the gas is greatly compressed. The term “diesel particulate filter (or DPF)”, as used herein, is defined to mean any device positioned downstream from a diesel engine and designed to remove diesel particulate matter, such as the non-limiting example of soot from diesel exhaust gas.

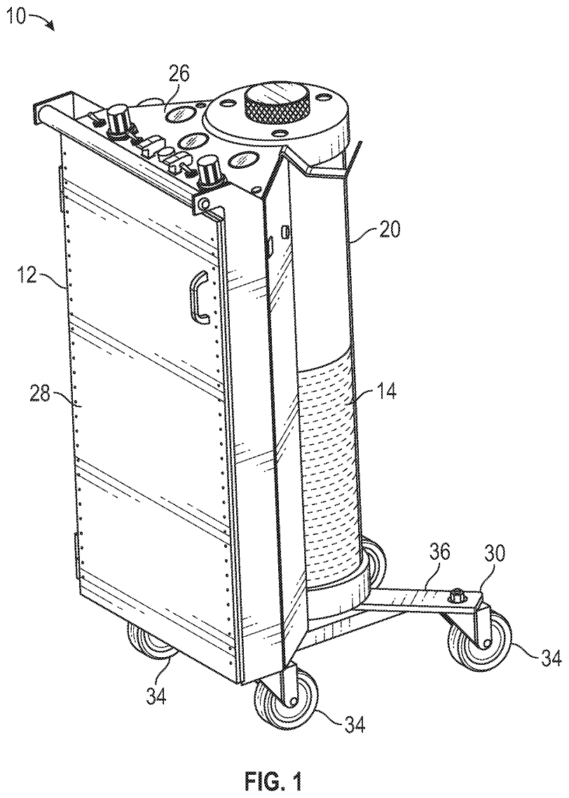

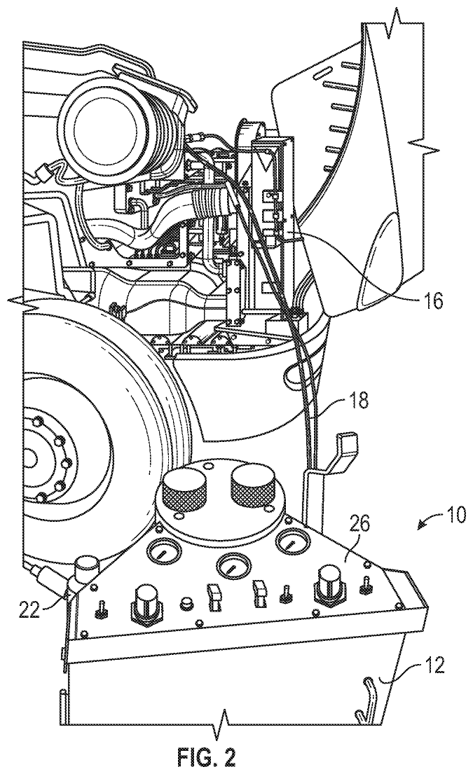

Referring now to FIGS. 1 and 2, a diesel engine cleaning system is shown generally at 10. Generally, the diesel engine cleaning system 10 (hereafter “cleaning system”) creates a compressed cleaning foam from a mixture of a compressed gas and a cleaning liquid. The compressed cleaning foam is conveyed into selected internal portions of a diesel engine through one or more delivery lines with the diesel engine running at low or idle speeds. Once the compressed cleaning foam exits the delivery lines and enters the selected portions of the running diesel engine, the volume of the compressed cleaning foam greatly expands. The expanding cleaning foam contacts internal elements and components of the diesel engine within the selected portions of the running diesel engine. The contact of the expanding cleaning foam against the internal diesel engine elements and components provides both a cleaning action against those elements and components and also provides a capillary action for conveying the cleaning foam through downstream elements and components within the diesel engine. The expanding cleaning foam is effective to remove diesel particulate matter, such as the non-limiting example of soot, from the surfaces of the internal elements and components of the engine. In certain embodiments, the resulting mixture of the cleaning foam and the removed diesel particulate matter can be incinerated by a diesel particulate filter. In certain instances, the resulting exhaust gas has the composition of carbon dioxide (CO2) and steam (water).

Referring now to FIGS. 1, 2 and 3, the cleaning system 10 includes a machine 12 and a volume of cleaning liquid, shown schematically at 14. The machine 12 is configured to create a compressed cleaning foam from a mixture of a compressed gas and the cleaning liquid 14. The compressed cleaning foam is conveyed into selected internal portions of a diesel engine 16 through one or more delivery lines 18, with the diesel engine 16 running at low or idle speeds.

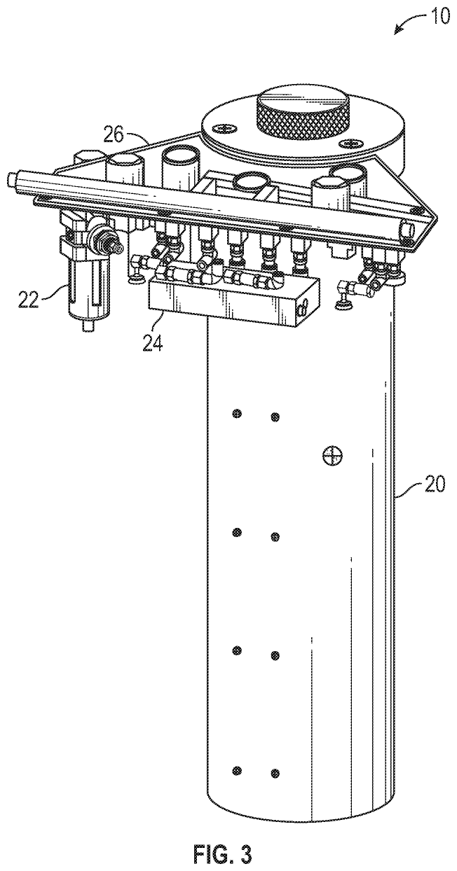

Referring now to FIGS. 1 and 3, the machine 12 includes a reservoir 20, a compressed gas inlet assembly 22, a mixing assembly 24, a control assembly 26, an enclosure 28 and an optional roller system 30.

Referring again to FIGS. 1 and 3, the reservoir 20 is configured for several functions. First, the reservoir 20 is configured to store a volume of the cleaning liquid 14. Second, the reservoir 20 is configured to receive a volume of compressed gas. Third, the reservoir 20 is configured to facilitate interaction of the volume of compressed gas with the volume of cleaning liquid such as to form a pressurized cleaning liquid. Finally, the reservoir 20 is configured to release the pressurized cleaning liquid upon demand. In the illustrated embodiment, the reservoir 20 has the form of a cylindrical tank arranged in an upright orientation. Alternatively, the reservoir 20 can have any structure, orientation and/or arrangement, sufficient to store a volume of the cleaning liquid, receive a volume of compressed gas, facilitate interaction of the volume of compressed gas with the volume of cleaning liquid such as to form a pressurized cleaning liquid and release the pressurized cleaning liquid upon demand.

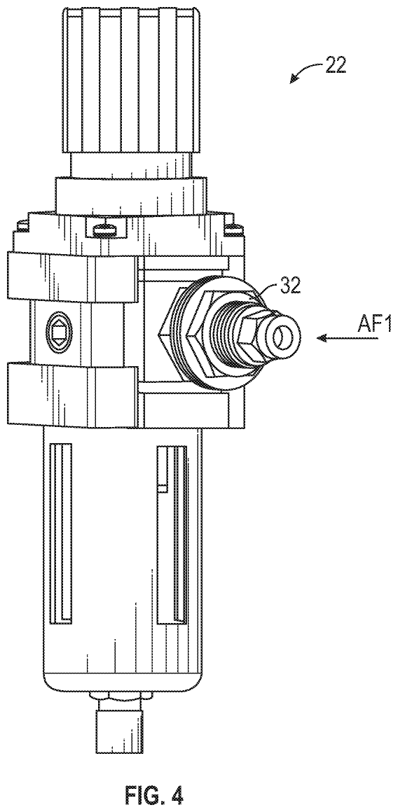

Referring again to FIG. 4, the compressed gas inlet assembly 22 includes a compressed gas inlet port 32 configured to receive compressed gas from an external source of compressed gas (not shown), as illustrated by direction arrow AF1. The compressed gas inlet assembly 22 is configured to filter and condition the incoming compressed gas. The filtered and conditioned compressed gas flows through the compressed gas inlet assembly 22 to an outlet port (not shown), which is in fluid communication with the reservoir 20. In the illustrated embodiment, the compressed gas inlet assembly 22 is conventional in the compressed gas art. However, in other embodiments, novel structures and assemblies, sufficient to receive compressed gas from an external source, filter and condition the incoming compressed gas, and be in fluid communication with the reservoir 20, can be used. In the illustrated embodiment, the compressed gas is air. However, it is contemplated that other gases can be used. It is also contemplated that the source of compressed air can be internal to the machine 12.

Referring now to FIG. 3, the mixing assembly 24 is configured to create a compressed cleaning foam from the combination of the pressurized cleaning liquid 14 flowing from the reservoir 20 and the compressed gas flowing from the compressed gas inlet assembly 22. The mixing assembly is further configured to convey the compressed cleaning foam to one or more delivery lines 18, for subsequent delivery to selected internal portions of the diesel engine 16. The mixing assembly 24 will be discussed in more detail below.

Referring again to FIGS. 1 and 3, the control assembly 26 includes a plurality of controls in communication with the reservoir 14, compressed gas inlet assembly 22 and mixing assembly 24. The control assembly 26 is configured to control the production of the compressed cleaning foam, including the quality of the cleaning foam, the flow rate of the compressed cleaning foam and the compression of the cleaning foam. The control assembly 26 can include any desired controls sufficient for the functions described herein.

Referring now to FIGS. 1 and 2, the enclosure 28 is configured to house and support various components of the machine 12. In the illustrated embodiment, the enclosure 28 is formed from metallic materials and has a trapezoidal cross-sectional shape with the reservoir 20 extending from the smaller base side of the trapezoid. In alternate embodiments, the enclosure 28 can have any desired cross-sectional shape, size or configuration and can be made from any desired material or materials sufficient to house and support various components of the machine 12.

Referring now to FIG. 1, the optional roller system 30 is configured to support the machine 12 and is further configured to provide the machine 12 with portability, that is, the optional roller system 30 is configured to facilitate the movement of the machine 12 from one location to another. In the illustrated embodiment, the optional roller system 30 includes a plurality of rollers 34 extending in a downward direction from the machine 12 from a framework 36. However, it should be appreciated that the optional roller system 30 can be formed from other structures, mechanisms and devices sufficient to support the machine 12 and facilitate the movement of the machine 12 from one location to another. It should also be appreciated that the roller system 30 is optional and not required for operation of the cleaning system 10.

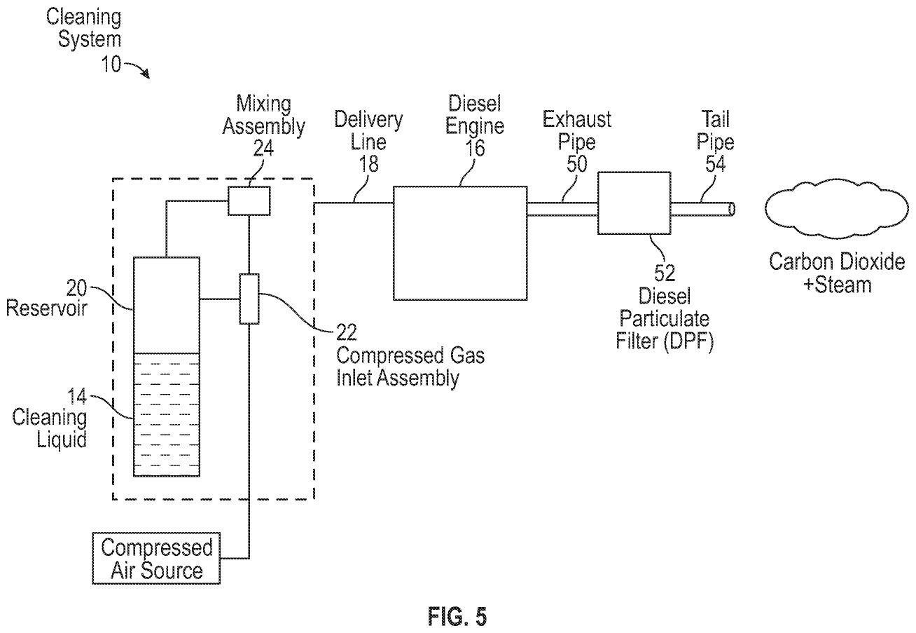

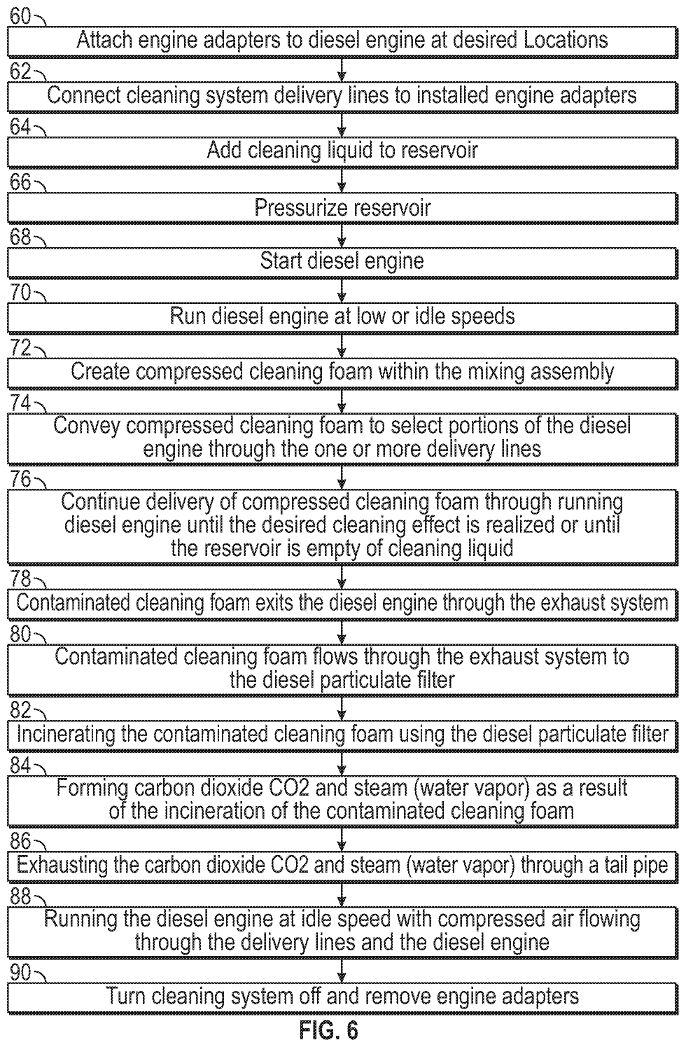

Referring now to FIGS. 5 and 6, the general structure, operation and use of the cleaning system 10 will now be described. Referring first to FIG. 5, the cleaning system 10 is schematically illustrated and includes the cleaning liquid 14 contained in the reservoir 20. The compressed gas inlet assembly 22 receives a supply of compressed gas from an external source and provides filtered and conditioned compressed gas to the reservoir 20 and the mixing assembly 24. The mixing assembly 24 is in fluid communication with selected internal components of the diesel engine 16 via one or more delivery lines 18. An exhaust pipe 50 fluidly connects the diesel engine 16 to a diesel particulate filter 52 in a manner such as to convey combustion exhaust gas from the diesel engine 16. The exhaust system 50 can include one or more exhaust pipes as is known in the industry. Finally, a tail pipe 54 extends from the diesel particulate filter 52 and is configured to exhaust emissions from the diesel particulate filter 52.

Referring now to FIGS. 5 and 6 in an initial operational step 60, adapters (not shown) are connected to the diesel engine at locations wherein it is desired to input the compressed cleaning foam. One non-limiting example of a desired location is the intake manifold containing the valve drive trains. However, other locations can be used. In a next operational step 62, the cleaning system delivery lines 18 are connected to the installed diesel engine adapters. Conventional methods of connecting the delivery lines 18 to the installed diesel engine adapters can be used. In a next operational step 64, the cleaning liquid 14 is added to the reservoir 20. In the illustrated embodiment, the cleaning liquid 14 is a diesel EGR system cleaner configured to dissolve carbon deposits on contact. One non-limiting example of a suitable cleaning liquid is the Gulf Select Diesel EGR & Induction System Cleaner, product number GS620, marketed by Gulf Select, headquartered in Walbridge, Ohio. However, it should be appreciated that the cleaning system 10 can be configured for operation with other suitable cleaning liquids.

Referring again to FIGS. 5 and 6 in a next operational step 66, the reservoir 20 is pressurized with compressed gas. In the illustrated embodiment, compressed gas is conveyed from the compressed gas inlet assembly 22 to the reservoir 20 for use in pressurizing the reservoir 20. However, in other embodiments, other sources of compressed gas can be used to pressurize the reservoir 20. In the next operational steps 68 and 70, the diesel engine 16 is started and run at low or idle speeds. Advantageously, the cleaning system 10 effectively cleans the selected internal portions of the diesel engine 16 with the diesel engine 16 running at low or idle speeds.

Referring again to FIGS. 5 and 6 in a next step as shown in operational step 72, the cleaning system 10 creates the compressed cleaning foam within the mixing assembly 24 from the mixture of the compressed gas and the pressurized cleaning liquid as discussed above. The formation of the compressed cleaning foam will be discussed in more detail below. In a next operation step 74, the compressed cleaning foam is conveyed to select portions of the diesel engine 16 through the one or more delivery lines 18, with the diesel engine 16 continuing to run at low or idle speeds. Within the running diesel engine 16, the volume of the compressed cleaning foam expands rapidly. In certain embodiments, the volumetric expansion of the compressed cleaning foam within the diesel engine 15 can be 50 to 200 times the volume of the compressed cleaning foam within the one or more delivery lines 18. The expansion of the compressed cleaning foam within the diesel engine 16 provides cleaning action with the internal elements and components of the diesel engine 16 by dissolving the diesel engine particulate matter. The expansion of the compressed cleaning foam also provides a capillary action for conveying the expanding cleaning foam through the internal elements and components of the diesel engine 16. As the compressed cleaning foam moves internally within the diesel engine 16, the compressed cleaning foam dissolves the diesel engine particulates to form a contaminated cleaning foam.

Referring again to FIGS. 5 and 6 in a next operational step 76, delivery of the compressed cleaning foam to the running diesel engine 16 is continued until the desired cleaning effect is realized or until the reservoir 20 is empty of cleaning liquid 14.

Referring again to FIGS. 5 and 6 in a next operational step 78, with the diesel engine 16 still running at low or idle speeds, the contaminated cleaning foam exits the diesel engine 16 through the exhaust system 50. Next, as shown in operational step 80, the diesel particulate filter 52 is configured to receive the contaminated cleaning foam flowing through the exhaust system 50. The diesel particulate filter 52 is conventional in the art.

Referring again to FIGS. 5 and 6 in a next operational step 82, the diesel particulate filter 52 is used to incinerate the contaminated cleaning foam, including the dissolved diesel engine particulate matter. In a next operational step 84, carbon dioxide CO₂ and water are formed as a result of the incineration of the contaminated cleaning foam within the diesel particulate filter 52. Next, as shown in operational step 86, the incineration of the contaminated cleaning foam within the diesel particulate filter 52 forms by-products of carbon dioxide CO₂ and steam (water vapor).

Referring again to FIGS. 5 and 6 in a next operation step 88, the diesel engine 16 is run at idle speed and compressed gas is forced through the delivery lines 18 and through the selected internal portions of the diesel engine 16. In a manner similar to operational step 66, the input port 22 can be used as the source of the compressed gas, although such is not required. In a final operational step 90, the cleaning system 10 is deactivated and the engine adapters are removed from the diesel engine 16.

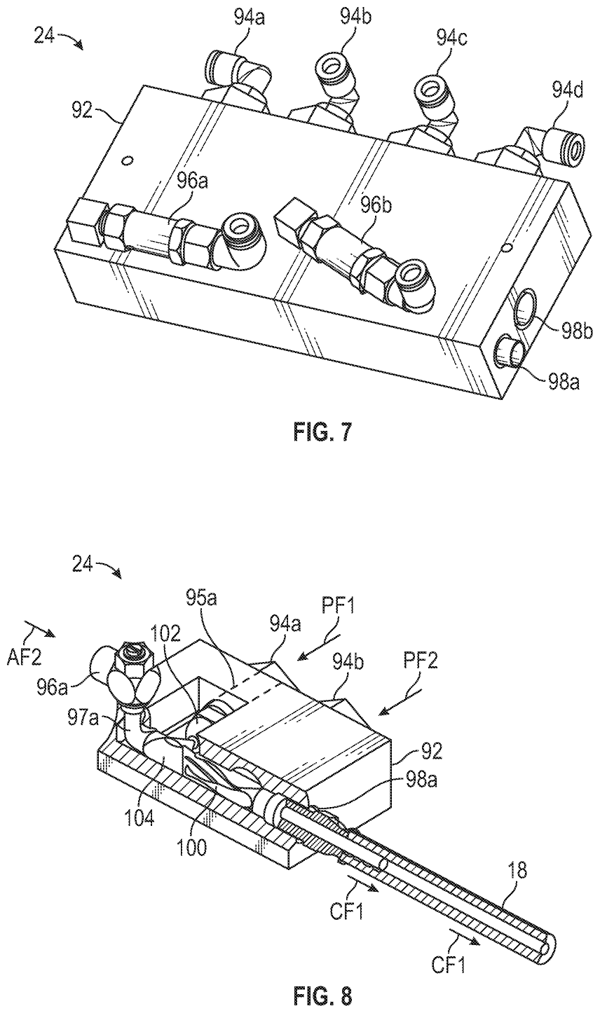

Referring now to FIGS. 7 and 8, the mixing assembly 24 is illustrated. The mixing assembly 24 includes a body 92 configured to support a plurality of input ports 94a-94d and 96a-96b (for purposes of clarity, FIG. 8 only illustrates input ports 94a, 94b and 96b). The input ports 94a-94d are configured to receive pressurized cleaning liquid from the reservoir 20 as schematically illustrated by direction arrows PF1 and PF2. The input ports 96a-96b are configured to receive compressed gas from the compressed gas inlet assembly 22 as schematically illustrated by direction arrows AF2. The input ports 94a-94d and 96a-96b can have any suitable structure.

Referring again to FIGS. 7 and 8, the body 92 is further configured to support a plurality of output ports 98a-98b (for purposes of clarity, FIG. 8 only illustrates output port 98a). The output ports 98a-98b are configured for connection to delivery lines 18 and further configured to convey compressed cleaning foam formed within the body 92 to the delivery lines 18, as schematically illustrated by direction arrows CF1. The output ports 98a-98b can have any suitable structure.

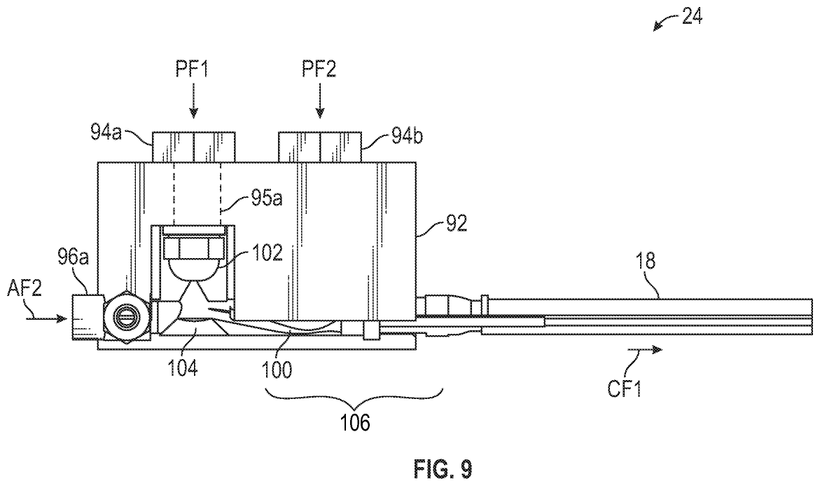

Referring now to FIGS. 8 and 9, the body 92 includes one or more mixing chambers 100 located within the body 92. The mixing chambers 100 are in fluid communication with the input ports 94a-94b via a plurality of internal conduits (for purposes of clarity, only lone internal conduit 95a is illustrated). The internal conduit 95a can have any desired structure sufficient to convey compressed cleaning foam to the mixing chamber 100. The mixing chambers 100 are also in fluid communication with input ports 96a, 96b via a plurality of internal conduits (for purposes of clarity, only lone internal conduit 97a is illustrated). The internal conduit 97a can have any desired structure sufficient to convey compressed gas to the mixing chamber 100.

Referring again to FIGS. 8 and 9, the body 92 further houses a plurality of jets 102, positioned at an inward end of the internal conduit 95a and configured to spray the pressurized cleaning liquid conveyed by the internal conduit 95a into the flow of compressed gas conveyed by the internal conduit 97a. The intersection of the sprayed, pressurized cleaning liquid and the compressed gas is labeled as reference character 104.

Referring now to FIG. 9, a transitional area 106 is formed immediately downstream from the mixing chamber 100. Within the transitional area 106, the pressurized cleaning liquid reacts with the compressed gas to form a transitional compressed cleaning foam. The transitional time period is short, thereby allowing a rapid conversion of the pressurized cleaning liquid into the compressed cleaning foam having a high expansion rate. The high expansion rate of the compressed cleaning foam is configured to propel the compressed cleaning foam through the output ports 98a-98b of the body 92, where the compressed cleaning foam and is conveyed by the delivery line 18 to the diesel engine 16.

Referring again to FIG. 7, the volume of the pressurized cleaning liquid provided to the mixing chamber 100 within the body 92 can be controlled through selective activation and use of the input ports 94a-94d. As one non-limiting example, a small displacement diesel engine may only require a limited volume of compressed cleaning foam. In this case, only one or two of the input ports 94a-94d need be activated and used. In another example, a large displacement diesel engine may require a large volume of compressed cleaning foam. In this case, all of the input ports 94a-94d may be activated and used. In a similar manner, the volume of the pressurized gas flowing from the compressed gas inlet assembly 22 to the input ports 96a-96b can be controlled.

The cleaning system 10 provides many benefits, however all benefits may not be present in all embodiments. The cleaning system 10 provides significant cleaning without the need for teardown of the diesel engine 16. Second, the cleaning system reduces component failures. Third, the cleaning system 10 reduces diesel engine downtime. Fourth, the cleaning system 10 increases the reliability of the diesel engine 16. Fifth, the cleaning system 10 reduces on-road service calls and potential towing costs. Sixth, the cleaning system 10 increases the fuel efficiency of the diesel engine 16. Seventh, the cleaning system 10 increases the power of the diesel engine as the diesel engine is under load. Eighth, the cleaning system 10 increases the longevity of the vehicle. Ninth, the cleaning system 10 increases the resale value of the vehicle. Finally, the cleaning system 10 reduces the overall operating expenses of the diesel engine and the vehicle.

The principle and mode of operation of the diesel engine cleaning system and method of use have been described in certain embodiments. However, it should be noted that the diesel engine cleaning system and method of use may be practiced otherwise than as specifically illustrated and described without departing from its scope.

What is claimed is:

1. A diesel engine cleaning system comprising:
a reservoir configured to contain and pressurize cleaning liquid;
a mixing assembly configured to receive the pressurized cleaning liquid from the reservoir and also configured to form a compressed cleaning foam from a mixture of the pressurized cleaning liquid and compressed gas; and
one or more delivery lines configured to deliver the compressed cleaning foam from the mixing assembly to select internal portions of the diesel engine;
wherein the compressed cleaning foam is configured to expand within the internal portions of the diesel engine and remove diesel particulate matter from surfaces of the internal portions of the diesel engine with the diesel engine running at low or idle speeds.

2. The diesel engine cleaning system of claim 1, wherein the cleaning liquid is Gulf Select Diesel EGR & Induction System Cleaner, product number GS620.

3. The diesel engine cleaning system of claim 1, wherein the compressed gas is air.

4. The diesel engine cleaning system of claim 1, wherein the mixing assembly includes a plurality of jets, configured to spray the pressurized cleaning liquid into a flow of compressed gas.

5. The diesel engine cleaning system of claim 1, wherein the compressed cleaning foam has a volume within the delivery lines, and wherein the compressed cleaning foam has a volumetric expansion within the diesel engine in a range of from about 50 to 200 times.

6. The diesel engine cleaning system of claim 1, wherein the diesel particulate matter removed from the diesel engine is incinerated by a diesel particulate filter.

7. The diesel engine cleaning system of claim 6, wherein by-products of the incineration of the diesel particulate matter includes carbon dioxide and steam.

8. A method of cleaning select internal portions of a diesel engine comprising the steps of:
pressurizing a cleaning liquid;
mixing the pressurized cleaning liquid with a compressed gas to form a compressed cleaning foam;
conveying the compressed cleaning foam to select internal portions of the diesel engine; and
facilitating expansion of the compressed cleaning foam within the internal portions of the diesel engine such that the compressed cleaning form removes diesel particulate matter from surfaces of the internal portions of the diesel engine with the diesel engine running at low or idle speeds.

9. The method of claim 8, wherein the cleaning liquid is Gulf Select Diesel EGR & Induction System Cleaner, product number GS620.

10. The method of claim 8, wherein the compressed gas is air.

11. The method of claim 8, including the step of spraying the pressurized cleaning liquid into a flow of compressed gas with a plurality of jets.

12. The method of claim 8, including the step of expanding the volume of the compressed cleaning foam within the diesel engine in a range of from about 50 to 200 times.

13. The method of claim 8, including the step of incinerating the diesel particulate matter removed from the diesel engine.

14. The method of claim 13, including the step of forming carbon dioxide and steam as by-products of the incinerated diesel particulate matter.

15. A mixing assembly for use in a diesel engine cleaning system, the mixing assembly comprising:
a body;
one or more input ports connected to the body and configured to receive a pressurized cleaning liquid;
one or more input ports connected to the body and configured to receive pressurized gas;
one or more mixing chambers configured to receive the pressurized cleaning liquid and the pressurized gas, the one or more mixing chambers further configured to form compressed cleaning foam from a mixture of the pressurized cleaning liquid and the pressurized gas; and
one or more delivery lines in fluid communication with the one or more mixing chambers, the one or more delivery lines configured to convey the compressed cleaning foam to select internal portions of the diesel engine.

16. The mixing assembly of claim 15, wherein the compressed gas is air.

17. The mixing assembly of claim 15, wherein the mixing assembly includes a plurality of jets, configured to spray the pressurized cleaning liquid into a flow of compressed gas.

18. The mixing assembly of claim 1, wherein the compressed cleaning foam has a volume within the delivery lines, and wherein the compressed cleaning foam has a volumetric expansion within the diesel engine in a range of from about 50 to 200 times.

19. The mixing assembly of claim 15, wherein the compressed cleaning foam is configured to remove diesel particulate matter from the diesel engine and the removed diesel particulate matter is incinerated by a diesel particulate filter.

20. The mixing assembly of claim 19, wherein by-products of the incineration of the diesel particulate matter includes carbon dioxide and steam.
